(19) United States
(12) Patent Application Publication
(10) Pub. No.: US 2005/0252898 A1
(43) Pub. Date: Nov. 17, 2005

(54) Method for operating a welding device, and one such welding device

(76) Inventors: Kurt Blechinger, Wels (AT); Roland Ortner, Pettenbach (AT); Roland Schick, Sattledt (AT); Manfred Wittmann, Rutzenmoos (AT)

Correspondence Address: WILLIAM COLLARD;COLLARD & ROE, P.C., 1077 NORTHERN BOULEVARD, ROSLYN, NY, 11576, US

(21) Appl. No.: 10/518,573

(22) PCT Filed: Apr. 30, 2003
(86) PCT No.: PCT/AT03/00124

§ 371 Date: Dec. 22, 2004

(30) Foreign Application Priority Data
Jul. 4, 2002 (AT) 1002/2002

(51) Int. Cl. B23K 9/10

(52) U.S. Cl. 219/130.5

(57) ABSTRACT

The invention relates to a method for operating a welding device (1), in addition to a welding device (1) comprising an energy source (2), especially a current source, which is controlled or regulated by means of a control device (4), at least one welding torch (10) or an electrode, at least one device for detecting operating states, such as the welding temperature, and at least one calculating unit (29) which is connected to the at least one detection device and is used to process the operating states. At least one device (35) is used to store instructions according to which the operating states are processed and states with which the processed operating states are compared. The inventive welding device also comprises at least one device (36) which is connected to the calculating unit (29) and is used to transmit messages to external receivers (37) in such a way that associated messages can be automatically transmitted to the external receivers (37) according to the results of said comparison.

The invention relates to a method for operating a welding apparatus, wherein a welding torch or an electrode is fed with controlled or regulated electric power, and wherein, at least during the welding procedure, operating states are detected and transmitted to a computing unit and processed in said computing unit.

The invention further relates to a welding apparatus including an energy source, particularly a power source, preferably controlled or regulated by the aid of a control device, and at least one welding torch or an electrode, particularly a welding wire, and further including at least one device for the detection of operating states and at least one computing unit connected with the at least one detection device and provided for the processing of said operating states.

In the following, welding apparatus is meant to denote both welding devices such as, e.g., hand-held devices and welding plants. The present invention is applicable to welding apparatus and plants of various technologies such as, e.g., MIG (metal—inert gas) welding, MAG (metal—active gas) welding, TIG (tungsten—inert gas) welding or similar protective-gas welding methods, or various other types of welding methods.

Welding apparatus, particularly welding plants in fully or partially automated production lines, are to an increasing extent equipped with operating devices, control devices and display devices or with interfaces for the connection to computing devices or for the connection to data networks. Modern welding apparatus equipped with interfaces, e.g. OPC (object link embedding for process control) interfaces, permit, for instance, remote control from a computer on the internet or remote diagnoses by the transmission of data essential to the welding procedure. To process such data, welding apparatus comprise internal computing units or are connected with computing units via said interfaces.

In order to monitor operating states of the welding apparatus at least during the welding procedure, parameters essential to the welding procedure are detected. The term operating states encompasses both operating parameters such as, e.g., welding current, temperature or data relating to the protective gas, and, for instance, visually detected data displaying the welding process or welding result, or even control information. Thus, it is, for instance, feasible to record the welding site by means of a camera so as to allow problems occurring during the welding process such as, e.g., consumed electrodes to be concluded therefrom by suitable image processing. It would likewise be possible to conclude the quality of the weld from pictures recorded of the weld after welding has been completed.

At present, special operating states such as, e.g., errors during the welding procedure are optically or acoustically presented by the operating and display unit of the welding apparatus, so that the responsible person will recognize such an error at the next look on the welding apparatus and consequently be able to eliminate the same. Also known are methods in which error messages are forwarded to a central unit so as to enable the latter to take the necessary steps in order to eliminate an error or change an operating state. Highly valuable time will frequently pass before the respective information on a particular operating state, for instance an error during the welding procedure, has reached the respectively responsible person, and high costs may occur by possible production losses.

It is, thus, the object of the present invention to provide a method for operating a welding apparatus of the initially defined kind, and a welding apparatus of the type mentioned, which enable the rapid detection of a certain operating state and, in order to avoid long downtimes, the automatic taking of appropriate steps such that the information on the respective operating state will rapidly arrive at a receiver provided therefor.

The object according to the invention, in method terms, is achieved in that the detected operating states are processed according to stored specifications and compared with stored states, and that messages automatically allocated as a function of the comparative results are transmitted to external receivers. By the welding method according to the invention, special operating states are rapidly recognized and messages allocated as a function of the recognized operating states are transmitted to external receivers. In doing so, it is, for instance, feasible to detect the operating state of the welding wire by monitoring the welding wire supply coil, and transmit to an external receiver, shortly before the end of the wire, the allocated message according to which welding wire supplies are running short. The external receiver may, for instance, be a computer of the stock keeper, who will then be reminded that a new welding wire coil will have to be procured and taken to the welding apparatus. In doing so, the transmitted messages are uniquely allocated to the detected operating states, for instance errors, and preferably available in text form. The usually required translation of an error code by the operating personnel will, thus, be rendered superfluous, whereby valuable time will be saved and errors due to misinterpretations of error codes will be reduced. It would, for instance, also be possible to detect the overcurrent of the welding wire feed motor and, upon exceeding of a defined limit value, transmit the allocated message of the core being contaminated to the responsible person, for instance a maintainer of the welding apparatus.

According to another characteristic feature of the invention, it is provided that the messages are transmitted to allocated external receivers as a function of the comparative results of the detected operating states with stored states. This means that selected persons or devices will be supplied with appropriate messages depending on the respective operating states occurring such as, for instance, malfunctionings. The external receivers may be comprised of various technical apparatus informing selected persons, or automatically taking necessary steps such as, e.g., ordering a new welding wire coil at the respective supplier.

Another improvement of the method according to the invention will be reached in that the messages are transmitted to external receivers in an accordingly allocated manner as a function of the results from comparisons of the operating states with stored states. In doing so, the way of transmission is adapted to the type of receiver. It is, thus, possible, for instance if the transmission of a message to the mobile phone of a works manager is desired, to realize such a transmission in the form of a short message (SMS), whereas the notification of a supplier can also be made via fax. The respective allocations of messages on the one hand, and of external receivers and the type of transmission to such receivers on the other hand, may be stored in tabular form or in the form of databases. In order to ensure that the respective data will always be updated and the messages will thus always reach the correct receivers, these data are preferably be input and modified via an appropriate data network.

The transmission of messages to external receivers may be implemented in various ways, for instance in the form of e-mails via data networks, particularly the internet, in the form of short messages via mobile networks or in the form of facsimile transmissions via telecommunication networks. The term short messages is to encompass both conventional short messages in text form (SMS—short messaging services) and modern multimedia short messages (MMS—multimedia messaging services), via which, for instance, even images, e.g. illustrating the welding site, can be transmitted.

The messages preferably available in text form may also be converted into acoustic signals and transmitted to the receivers via telecommunication or radio networks. In this manner, the allocated message will be issued at the receiver by an appropriate voice output.

According to a further characteristic feature of the invention, it is provided that the detected operating states are transmitted to the computing unit via a standardized interface, particularly the OPC (object link embedding for process control) interface. To this end, the detected operating states are converted into a standard format, particularly an OPC standard format, in the welding apparatus and transmitted to the computing unit. The use of such standard interfaces readily allows for the connection of the welding apparatus to other welding apparatus, or to computing units or data networks.

The transmission of the detected operating states to the computing unit is preferably implemented in the binary code.

In order to enable the computing unit to interpret the detected operating states, preprocessing of the detected operating states prior to their transmission to the computing unit will be suitable. Such preprocessing may be effected in the device for the detection of an operating state, for instance in the sensor itself or in a separate microprocessor, microcontroller or the like.

The above-mentioned stored specifications according to which the detected operating states are processed, and/or the stored states with which the detected operating states are compared, may also be stored in the computing unit.

Likewise, it is feasible to store these specifications and/or states, respectively, in a database connected with the computing unit.

In order to be able to allocate the respective messages to the respectively emitting welding apparatus in the event of production plants comprising several welding apparatus, it is further provided that a unique identification of the welding apparatus is transmitted to the external receivers along with said messages. The addressed receiver will, thus, immediately recognize the welding apparatus concerned. Such a unique identification is also necessary for the intercommunication between several welding apparatus. It is, for instance, conceivable that another welding apparatus functions as the external receiver and, upon transmission of an error message or the like, takes over the welding procedure, for instance, from the welding apparatus having emitted said message.

The object according to the invention is also achieved by a welding apparatus of the defined kind, in which there are provided at least one device for the storage of specifications according to which the operating states are processed, and of states with which the processed operating states are compared, and, furthermore, at least one device for the transmission of messages to external receivers, which is connected with the computing unit, such that messages allocated as a function of the comparative results are automatically transmittable to said external receivers. At the occurrence of special operating states such as, e.g. malfunctionings during the welding procedure, such a welding apparatus will, therefore, enable the indication of the same and the transmission of respective messages to the respective receivers.

The device for transmitting messages may, for instance, be comprised of a computing unit including a connection to a data network, particularly the internet, thus enabling the message to be transmitted in the form of an e-mail.

The transmission device may also be comprised of a mobile phone, preferably a GSM (global system for mobile communication) mobile phone.

Furthermore, a transmission device may also be comprised of a facsimile transmitter, via which the respective messages are transmitted per fax to the desired receiver(s).

Moreover, a transmission device may also be comprised of an acoustic transmitter unit, which converts the message into an acoustic signal to be transmitted to the responsible receiver via a suitable telecommunication network or radio network.

A welding apparatus may be equipped with one or several different devices for the transmission of messages to external receivers. The transmission device is connected with the computing unit of the welding apparatus and may be arranged separately from the welding apparatus or integrated within the same. With the external arrangement of the transmission devices, these may also be connected with several welding apparatus, thus assuming the function of transmitting messages of different welding apparatus.

The devices for the detection of operating states such as, for instance, sensors or the like, and optionally the control device for the control and regulation of the energy source for operating the welding apparatus, may be connected with the computing unit by a standardized interface, particularly an OPC (object link embedding for process control) interface. By a standardized interface, the connection of the welding apparatus to other welding apparatus or data networks or the like will be simplified.

The computing unit for the processing of operating states may be integrated in the welding apparatus. Hence results a compact unit.

If required, a unit for the preprocessing of detected operating states prior to their transmission to the computing unit may be provided. Such a preprocessing unit is able to recognize faulty operating states or average measuring values or measuring states prior to processing.

A database connected with the computing unit may be provided for the storage of specifications according to which the operating states are processed, and/or of states with which the processed operating states are compared. This database may be integrated in the welding apparatus, or communicate with the welding apparatus, via a suitable interface and a suitable data network.

If an identification device is provided in the welding apparatus, which is connected with the computing unit or the at least one device for the transmission of messages to external receivers, the transmitted message can be provided with a unique identification and the allocation of the message to a particular welding apparatus can, thus, be clearly assessed.

If an external receiver is comprised of another welding apparatus, the transmission of messages will also be feasible between different welding apparatus.

The detection device may, for instance, be comprised of a temperature sensor, which detects the temperature on the welding site.

Likewise, the detection device may be comprised of a camera, particularly a digital camera, which optically detects the operating state on the welding site, or also the condition of components of the welding apparatus.

Besides the examples mentioned above, innumerable other detection devices such as, e.g., electric current meters, gas sensors for the detection of the protective gas, optical sensors or many other means may be employed.

In the following, the invention will be explained in more detail by way of exemplary embodiments illustrated in the drawing.

Therein:

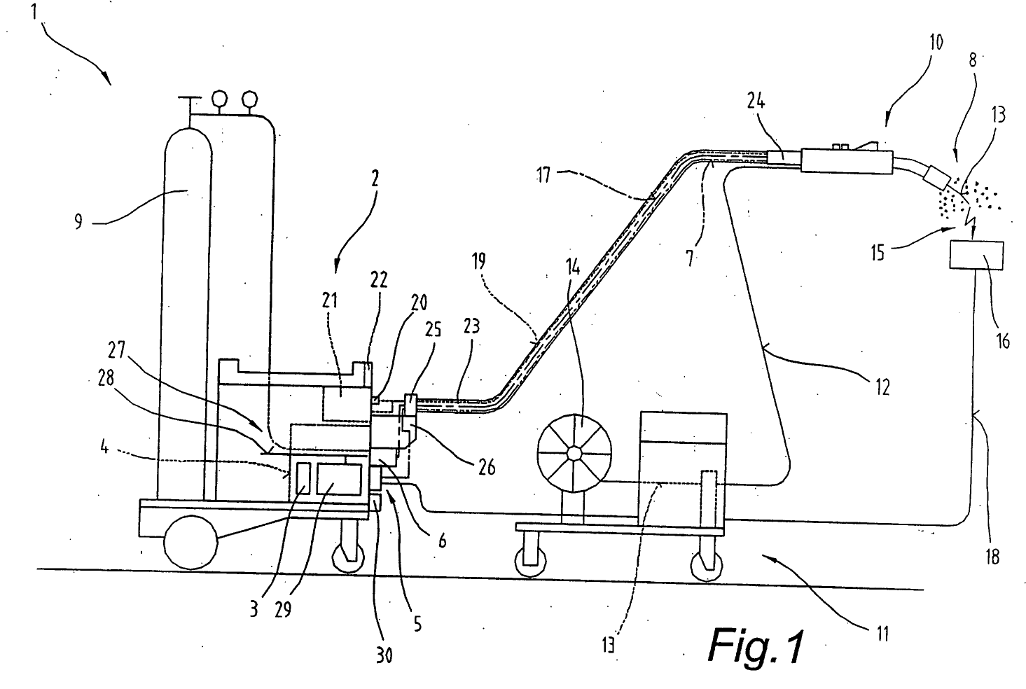

FIG. 1 depicts a welding apparatus with an integrated computing unit in a simplified schematic illustration;

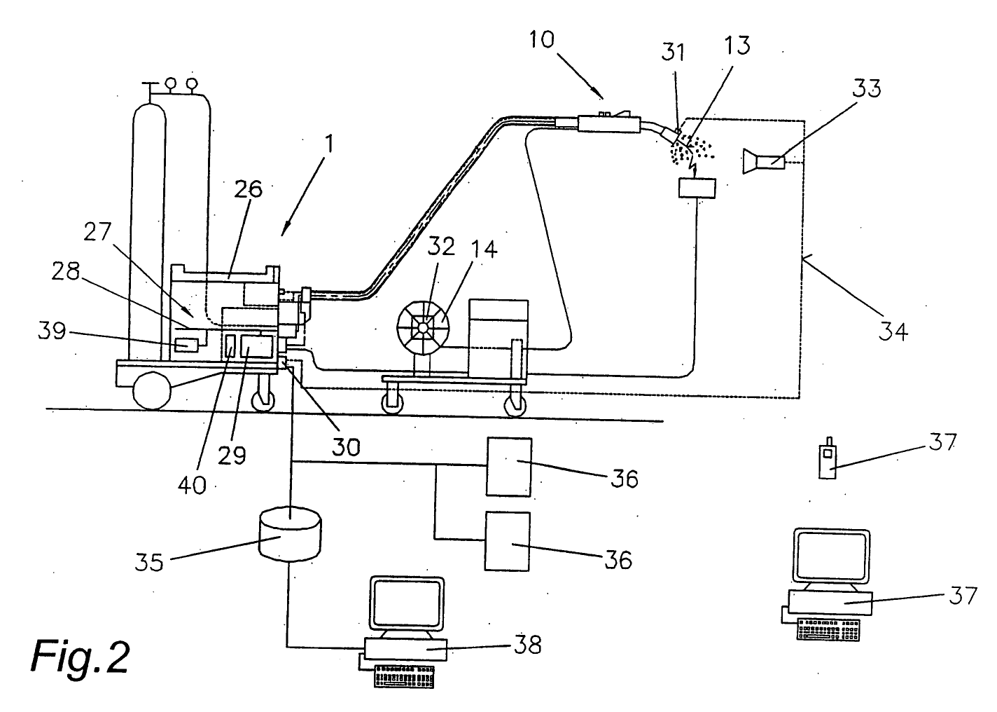

FIG. 2 is a schematic illustration of a welding apparatus according to the invention, including a device for the transmission of messages; and

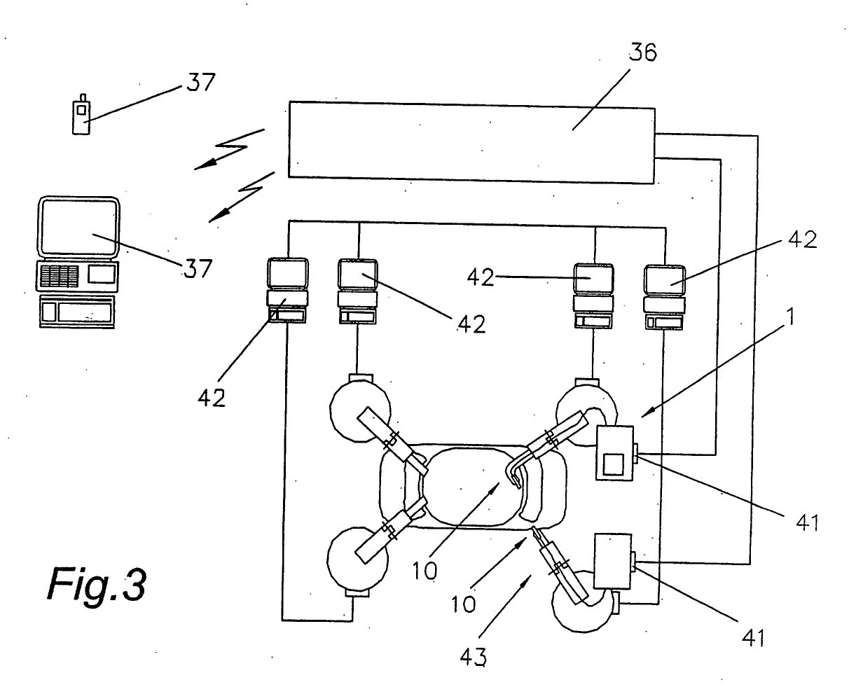

FIG. 3 is a diagrammatic view of a production line comprising two welding apparatus according to the invention.

FIG. 1 depicts a welding apparatus 1 to be used in various welding methods such as, e.g., MIG (metal—inert gas) welding methods, MAG (metal—active gas) welding methods, TIG (tungsten—inert gas) welding methods or electrode welding methods or the like. The welding apparatus 1 comprises an energy source 2, preferably a power source including a power element 3, a control and/or evaluation device 4 and a switch member 5 allocated to the power element 3 or control and/or evaluation device 4. The switch member 5, and the control and/or evaluation device 4, respectively, are connected with a control valve 6 arranged in a feed line 7 for a gas 8 and, in particular, a protective gas such as, for instance, carbon dioxide, helium, argon or the like, between a gas reservoir 9 and a welding torch 10.

In addition, a wire feeder 11 as usually employed in MIG/MAG welding processes can be activated by the control and/or evaluation device 4, a welding wire 13 being fed from a feed drum 14 into the region of the welding torch 10 via a feed line 12. It is, of course, possible to integrate the wire feeder 11 in the welding apparatus 1, as is known from the prior art, rather than designing the same as an accessory device as illustrated in FIG. 1.

The power required to build up an electric arc 15 between the welding wire 13 and a workpiece 16 is supplied from the power element 3 of the energy source 2 to the welding torch 10 or welding wire 13, respectively, through a welding line 17, wherein the workpiece 16 to be welded is likewise connected with the welding apparatus 1 and, in particular, the energy source 2 and, in particular, the power source via a further welding line 18, thus enabling a power circuit to build up over the electric arc 15.

To provide cooling of the welding torch 10, the welding torch 10 is connectable to a fluid reservoir 21 via a cooling circuit 19 with a flow control 20 interposed, whereby the cooling circuit 19, particularly a fluid pump used for the fluid contained in the fluid reservoir 21, is started as the welding torch 10 is being put into operation, thus effecting cooling of the welding torch 10 or welding wire 13, respectively.

The welding apparatus 1 further comprises an input and/or output device 22, via which different operating states of the welding apparatus 1 can be adjusted and/or displayed. In doing so, the operating conditions adjusted via the input and/or output device 22 are conveyed to the control and/or evaluation device 4, which in turn will subsequently activate the respective components of the welding apparatus 1.

The welding torch 10 illustrated is connected with the welding apparatus 1 via a hose package 23 housing the individual lines from the welding apparatus 1 to the welding torch 10. The hose package 23 is connected with the welding torch 10 via a connecting device 24, and the individual lines within the hose package 23 are connected with the respective connections of the welding apparatus 1 via appropriate connection sockets or plug-in connections. In order to ensure the appropriate strain relief of the hose package 23, the latter is connected with a housing 26 and, in particular, the housing of the welding apparatus 1 via a strain relief means 25.

The welding apparatus 1 may comprise an internal data transmission system 27, particularly an internal bus system 28, which enables the transfer of data between the individual components or assemblies of the welding apparatus 1, such as, for instance, the energy source 2 and/or the power element 3 and/or the control and/or evaluation device 4 and/or the welding torch 10 and/or the wire feeder 11 and/or the input and/or output device 22 and/or the like.

The communication of the components of the welding apparatus 1 via the internal bus system 28 is implemented by the aid of a preferably standardized data format such as, e.g., according to the OPC (object link embedding for process control) standard. For the processing of control commands or the like, a computing unit 29 may be integrated in the welding device 1, or connected to the same by an appropriate interface 30. The computing unit 29 may serve to control specified functions of the welding device or process and pass on certain detected operating states.

FIG. 2 depicts a welding apparatus 1 configured according to the present invention. To this end, means for the detection of operating states such as, for instance, temperature sensors 31, sensors 32 for the monitoring of the feed drum 14 for the welding wire 13, cameras 33 for the visual detection of the welding location are provided, which are connected with the computing unit 29 via appropriate lines 34. A memory unit 35 is connected to, or integrated with, the computing unit 29 to store specifications according to which the detected operating states are to be processed, and states with which the processed operating states are to be compared. In accordance with the invention, the detected operating states such as, e.g., temperature, wire feed or the like are processed, for instance averaged, and compared with given values deposited in the memory unit 35, and messages allocated at the occurrence of special states are transmitted to external receivers 37. The input of a change of the data stored in the memory unit 35 may, for instance, be effected via a terminal 38. The messages are preferably available in text form so as to be immediately readable by the respective receiver 37. The conversion of text messages into acoustic signals and the transmission of the same via telecommunication or radio networks are conceivable too. In a preferred manner, an identification of the welding apparatus 1 is transmitted along with the sent message so as to enable the receiver to immediately allocate the message to the correct welding apparatus 1. An identification device 39, which may be connected with the computing unit 29, is provided for identification purposes. In the welding device 1, a unit 40 comprised, for instance, of a microprocessor or the like may be provided for the preprocessing of detected operating states.

FIG. 3 depicts a production plant comprising two welding apparatus 1, which are connected via appropriate interfaces 41, for instance standardized OPC (object link embedding for process control) interfaces, with a unit 36 for the transmission of defined messages to selected receivers. The welding torches 10 of the welding apparatus 1 are moved to the workpiece, for instance the body of a vehicle, by suitable robot arms 43. The robot arms 43 are controlled and regulated by networked control computers 42. The transmission unit 36 according to the invention, for instance at the occurrence of a malfunction, will transmit an allocated message, for instance “welding wire coil empty”, to a selected receiver, for instance the storage room, in a selected manner, for instance by SMS on a mobile phone. The person carrying and reading the external receiver 37 will, thus, be able to rapidly react to the error or detected operating state and, for instance, order a new wire coil to be taken to the welding apparatus 1. Thus, valuable time is saved and a continuous production cycle is guaranteed. By appropriate defaults, messages can be transmitted to a variety of receivers via a variety of media.

In the following, some detected operating states, allocated messages, allocated receivers and allocated ways of transmission in a welding procedure are given by way of example.

Detected operating state: “End of welding wire”

Message “Order wire coil” to stock keeper by fax

Message “Supply wire coil” to stacker operator by SMS

Message “Change wire coil” to operator by phone.

Detected operating state: “Motor overcurrent”

Message: “Core contaminated” to operator by phone.

Detected operating state: “Motor overcurrent”

Message: “Core contaminated” to operator by phone

It is, of course, feasible to transmit messages simultaneously to several different receivers in different ways or, upon emergence of a special operating state, transmit also several messages to several receivers.

1-26. (canceled)

27. A method for operating a welding apparatus, wherein a welding torch or an electrode is fed with controlled or regulated electric power, and wherein, at least during the welding procedure, operating states are detected and transmitted to a computing unit and processed in said computing unit, whereby the detected operating states are processed according to stored specifications and compared with stored state, characterized in that the detected operating states are transmitted to the computing unit via a standardized interface, and that messages automatically allocated as a function of the comparative results are transmitted to external receivers.

28. A method according to claim 27, wherein the messages are transmitted to allocated external receivers as a function of the comparative results.

29. A method according to claim 27, wherein the messages are transmitted to external receivers in an allocated manner as a function of the comparative results.

30. A method according to claim 27, characterized in that the messages are transmitted in the form of e-mails, via data networks, particularly the internet.

31. A method according to claim 27, characterized in that the messages are transmitted in the form of short messages via mobile networks.

32. A method according to claim 27, wherein the messages are transmitted in the form of facsimile transmissions via telecommunication networks.

33. A method according to claim 27, wherein the messages are converted into acoustic signals to be transmitted to receivers via telecommunication or radio networks.

34. A method according to claim 27, wherein the detected operating states are transmitted to the computing unit via an OPC (object link embedding for process control) interface.

35. A method according to claim 27, wherein the detected operating states are transmitted to the computing unit in the binary code.

36. A method according to claim 27, wherein the detected operating states are preprocessed prior to being transmitted to the computing unit.

37. A method according to claim 27, wherein the specifications and/or states are stored in the computing unit.

38. A method according to claim 27, wherein the specifications and/or states are stored in a database connected with the computing unit.

39. A method according to claim 27, wherein a unique identification of the welding apparatus is transmitted to the external receiver along with the messages.

40. A welding apparatus including an energy source (2), particularly a power source, preferably controlled or regulated by the aid of a control device (4), and at least one welding torch (10) or an electrode, particularly a welding wire, and further including at least one device for the detection of operating states and at least one computing unit (29) connected with the at least one detection device and provided for the processing of said operating states, and, furthermore, at least one device (35) for the storage of specifications according to which the operating states are processed, and of states with which the processed operating states are compared, and at least one device (36) for the transmission of messages to external receivers (37), which is connected with the computing unit (29), characterized in that the detection devices and optionally the control device (4) are connected with the computing unit (29) via a standardized interface, and that the transmission device (36) is configured for the automatic transmission to said external receivers (37), of messages allocated as a function of the comparative results.

41. A welding apparatus according to claim 40, wherein a transmission device (36) is comprised of a computing unit (29) including a connection to a data network, particularly the internet.

42. A welding apparatus according to claim 40, wherein the transmission device (36) is comprised of a mobile phone, preferably a GSM (global system for mobile communication) mobile phone.

43. A welding apparatus according to claim 40, wherein the transmission device (36) is comprised of a facsimile transmitter.

44. A welding apparatus according to claim 40, wherein the transmission device (36) is comprised of an acoustic transmitter unit.

45. A welding apparatus according to claim 40, wherein the detection devices and optionally the control device (4) are connected with the computing unit (29) by an OPC (object link embedding for process control) interface.

46. A welding apparatus according to claim 40, wherein the computing unit (19) for the processing of operating states is integrated in the welding apparatus.

47. A welding apparatus according to claim 40, wherein a unit (40) for the preprocessing of the detected operating states prior to their transmission to the computing unit (29) is be provided.

48. A welding apparatus according to claim 40, wherein a database (35) connected with the computing unit (29) is provided for the storage of the specifications according to which operating states are processed and/or of the states with which the operating states to be processed are compared.

49. A welding apparatus according to claim 40, wherein an identification device (39) is provided.

50. A welding apparatus according to claim 40, wherein an external receiver (37) is comprised of a welding apparatus.

51. A welding apparatus according to claim 40, wherein at least one detection device is comprised of a temperature sensor (31).

52. A welding apparatus according to claim 40, wherein at least one detection device is comprised of a camera (33), particularly a digital camera.
